(19) United States
(12) Patent Application Publication
(10) Pub. No.: US 2006/0064206 A1
(43) Pub. Date: Mar. 23, 2006

(54) Method and device for evaluating signals or data of an object detection system

(76) Inventors: Rudolf Merkel, Stutensee (DE); Uwe Zimmermann, Remseck (DE); Achim Pruksch, Neudenau (DE); Werner Uhler, Bruchsal (DE)

Correspondence Address: Striker Striker & Stenby, 103 East Neck Road, Huntington, NY, 11743, US

(21) Appl. No.: 10/532,694

(22) PCT Filed: Oct. 16, 2003
(86) PCT No.: PCT/DE03/03438

§ 371 Date: Apr. 26, 2005

(30) Foreign Application Priority Data
Dec. 20, 2002 (DE) 102 59 947.5

(51) Int. Cl. G05D 1/00

(52) U.S. Cl. 701/1

(57) ABSTRACT

A system for detecting objects, in particular for a motor vehicle, is proposed in which, with a radar sensor, the radar signals reflected by the object are processed for ascertaining the distance (d) and/or the relative or approach speed (Cv) of the object. The digital signals from at least one channel (I, Q) of the radar sensor are processed until a first evaluation capability is obtained as a distance signal (d) or as an approach speed signal (Cv), with which it is defined which data are ascertained and will be made available to an interface (6) between the radar sensor and a downstream control unit (7).

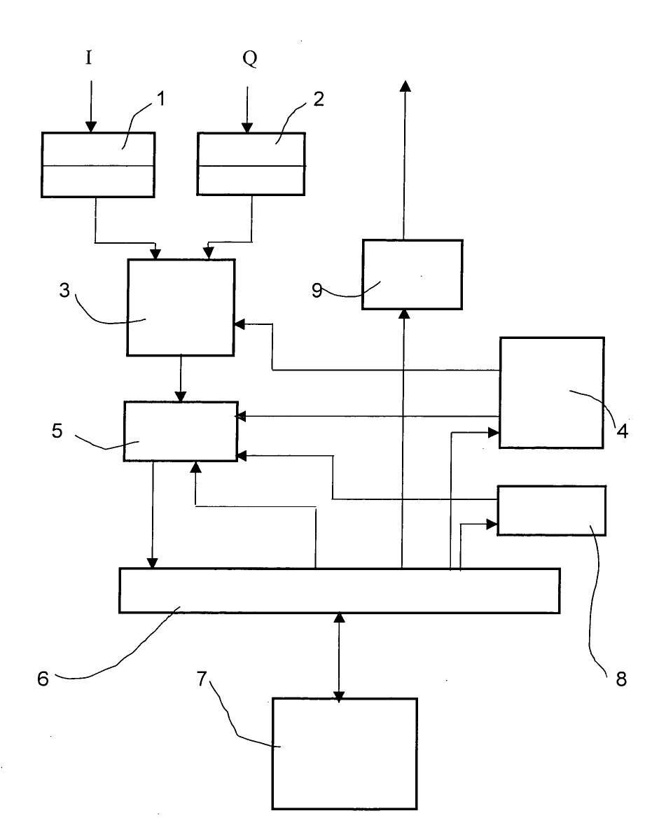

### PRIOR ART

The invention relates to a method and an arrangement for evaluating signals or data from a system for detecting objects, in particular for a motor vehicle, as generically defined by the preamble to the main claim.

Such a system may be employed for instance in adaptively regulating the travel speed of a motor vehicle and/or its distance from other objects. This regulation known per se can, without intervention by the driver, regulate a previously set travel speed and/or a previously set distance from a vehicle ahead, from objects located in the travel direction. This is done by taking into account the area around the motor vehicle and optionally still other parameters, such as weather and visibility conditions. Such regulation is also known as an adaptive cruise control system (ACC system). The ACC system must in particular, given the increasing density of traffic at present, be flexible enough to react suitably to all driving situations. This in turn requires an appropriate object detection sensor system, so that the measurement data required for the regulation will be furnished in every driving situation.

Sensors for an ACC system are known per se, as a rule having radar sensors or lidar, that have a range of about 100 to 150 m, with a detection angle of approximately 10\. Short-range distance sensors for parking assistance systems are also known per se, which are predominantly equipped with ultrasonic sensors.

It is known for instance from German Patent Disclosure DE 44 42 189 A1 that in a system for distance measurement in the area surrounding motor vehicles, sensors with transceiver units are used for both sending and receiving information. With the aid of the distance measurement, passive protection measures for the vehicle can be activated, for instance in the event of a front, side or rear-end collision. With an exchange of the information detected, an assessment of traffic situations can for instance be made for activating appropriate tripping systems.

It is furthermore known from German Patent Disclosure DE 199 63 005 A1 that a distance measurement can be performed with so-called pulse radar, in which a carrier pulse with a rectangular envelope of electromagnetic oscillation, for instance in the Gigahertz range, is transmitted. This carrier pulse is reflected from the target object, and from the time between the emission of the pulse and the arrival of the reflected radiation, the distance from the target and, with limitations, using the Doppler effect, the relative speed of the target object can also be easily determined. Such a measurement principle is described for instance in the textbook by A. Ludloff, “Handbuch Radar und Radarsignalverarbeitung” [Radar and Radar Signal Processing Manual], pages 2-21 to 2-44, published by Vieweg Verlag, 1993.

The basic layout of such a known radar sensor is designed such that the radar pulses reflected from the particular target object reach a receiver via antennas and are mixed in the receiver with the delayed pulses furnished by the pulse generator. The output signals of the receivers are delivered, after low-pass filtration and analog/digital conversion, to an evaluation unit.

In the aforementioned various applications, it is often necessary to use a so-called platform sensor for the various applications, such as parking assistance, precrash, ACC-Stop&Go, or TWD (for the German for Idle Angle Detector). Because of the properties of the sensor signals, however, this requires a certain intelligence in the sensor, which enables optimal evaluation of the sensor signal with regard to the various evaluation criteria. This evaluation must be optimized for cost reasons on the one hand, without on the other limiting the freedom for further developments in the future.

In particular, a switchover capability for switching from a distance measurement to a so-called Cv measurement, that is, determining the approach speed before a possible collision of vehicles (closing velocity (Cv) for precrash), should be able to run as simply as possible. So-called distance lists would be possible here, which can be forwarded to a control unit, but the various applications mentioned above require different kinds of distance lists. As a rule, very complicated application-specific algorithms in the sensor are required, by which different information must then be forwarded to the control unit, which leads to relatively high transmission rates at the interface between the sensor and the control unit. Care must also be taken, for reasons of cost and to simplify the circuitry, to use components for the interface that are already used in other areas in the vehicle, including in applications that are critical to safety.

### ADVANTAGES OF THE INVENTION

A system for detecting objects, in particular for a motor vehicle, and a method for evaluating the data signals occurring in it, in which with a radar sensor the radar signals reflected from the object are processed for ascertaining the distance and/or the relative or approach speed of the object, is advantageously further embodied according to the invention as follows. The digital signals from at least one channel of the radar sensor are processed only until a first evaluation capability is found as a distance signal or an approach speed signal. That is, the signal processing in the radar sensor is done only up to the signals that for the first time permit a simple physical interpretation.

Advantageously, a mode switchover for the evaluation as a distance signal as an approach speed signal can be effected, with which it is defined which data will be ascertained and made available to an interface between the radar sensor and a downstream control unit.

In a manner known per se, the digital signals from at least one channel, but preferably two channels I and Q of the radar sensor, after every sampling operation, can be delivered respectively to a data buffer of predetermined slot width and then processed within the slot width, for instance by means of a median filtration operation. For calculating the background by means of the median filtration, the digitized raw signals from the I and Q channels are thus delivered after each sampling operation to a data buffer of a determined slot width (such as 16 words). If the word width is 16 bits, some bits can be used for the analog/digitally converted values. Other bits may also serve as an auxiliary variable for the sorting algorithm for the median calculation, such as the age of the value, as a number between 0 and the slot width of −1.

In the next processing step, the aforementioned background correction is then effected along with a gain compensation, which may be required under some circumstances, between the I and Q channels. If necessary, the parameters pertaining to this may also be stored in a nonvolatile, read/write memory. This is then followed by the rationalization from the I and Q channels.

The signal data calculated in this way may also, with relatively little expense for resources, also be correlated in a matching filter with a reference signal course or reference peak in order to improve the signal-to-signal noise ratio, so that now only information about the result of correlation has to be further transmitted. In principle, for the distance measurement, now only a peak search algorithm is needed to arrive at the distance data.

The method of the invention is especially advantageous because in it a simple switchover to the so-called Cv mode, that is, ascertaining the approach speed of an object, can be performed and the background correction and rationalization described above can be dispensed with. The raw signals are recorded continuously within a range gate. Since in this evaluation mode the corresponding algorithm is examined for each sampled value, the data are available in real time in the connected control unit; that is, a requirement of a switchover time of 10 ms, for instance, for switching from distance measurement to the Cv mode can also be met for the precrash mode.

In the further course of the method of the invention, a data compression, which can be influenced by an external control unit, for instance, can also be done in a simple way. For instance, so-called calibration coefficients and measured values from the Cv mode, because of the small quantities of data, need not necessarily be sent in compressed form via the interface.

In an advantageous circuit arrangement for performing the method described above, a radar sensor has storage means and digital computation modules for performing and switching over the evaluation modes mentioned. In the radar sensor there is an interface controller, by way of which the radar sensor can be connected to a downstream control unit. The interface controller can be constructed such that the data are prepared for connection to a standardized bus system, such as the so-called CAN bus in a motor vehicle.

In an especially advantageous embodiment of the invention, a data processing program for performing the method of the invention or controlling the storage means and/or the digital computation modules in the radar sensor can be constructed such that the appropriate evaluation modes can be performed quickly and in a way that is economical in terms of resources.

In summary, transmitting background-corrected raw signals with a rationalization for the distance measurement has a number of advantages, especially because the data are easily interpreted and a data reduction from two channels (I and Q channels) can be ascribed to one data set. The previously usual transmission of purely raw signals conversely requires a high interface bandwidth, and the signals can be interpreted only with difficulty. Thus for the various applications, no changes need to be made in the basic signal processing or in the sensor, and as a result the signal processing functions in principle as a so-called black box.

A further data compression can be performed for instance by forwarding differential changes to the preceding measured value, and as a result the data transmission can be done by way of suitable inexpensive, proprietary interfaces. The data transmission rate, which can be reduced by data compression, is lower than the currently usable interface bandwidths of proprietary bus systems, such as a CAN bus, or other suitable interfaces.

This not only makes signal processing economical but at the same time also makes it possible to market the radar sensors even without an associated control unit. Since memory modules are as a rule more economical in the universally constructed control unit than in the specially constructed radar sensor, still further cost advantages are obtained.

The degree to which the signals are processed until after the rationalization and optionally also after the matching filter is secure in this respect even for future developments, since superimposed algorithms from the various applications in the control unit can be optimized independently of one another and independently of a software program in the radar sensor, for instance for detecting slow-moving and fast-moving objects.

### DRAWING

The method of the invention for evaluating the data from a system for detecting objects will be described in conjunction with the drawing, which shows a schematic block diagram of the course of the method.

### DESCRIPTION OF THE EXEMPLARY EMBODIMENT

The sole drawing FIGURE is a schematic block circuit diagram which shows the evaluation of signals, for instance from a pulse-modulated microwave radar, with a transmitter, operating for instance at a frequency of 24 GHz, and with receiver and mixing units. One such radar sensor is described in DE 199 63 005 A1 mentioned above as prior art; in this respect the furnishing of an I channel and a Q channel for determining the distance and relative speed values is described per se.

According to the block circuit diagram in the sole drawing FIGURE, the signals, digitized at a predetermined resolution (ADC resolution), from the channels I and Q of a radar sensor shown here are delivered after each sampling operation to a respective data buffer (shown symbolically in blocks 1 and 2) with a predetermined slot width, such as 16 words (age(n=log2(window width))), and then are processed within the slot width by means of a median filtration operation with a resolution m=ADC. The values m and n here represent the associated number of bits.

In the next method step, in block 3, a background correction is then effected for the channels I and Q jointly for the distance measurement of an object (d measurement), in which now only signal deflections from an ascertained background signal are further processed. If necessary, a gain compensation between the I and Q channels that may be necessary under some circumstances can be performed, and this is then followed by the computed rationalization of the signals from the I and Q channels.

In block 3 of the drawing, a routine is also shown with which the signal data calculated in this way are optionally correlated in a matching filter with a reference signal course or reference peak, so that now only information about the outcome of correlation needs to be further transmitted.

A further block 4 identifies a routine with which a switchover of the evaluation mode in block 3 to the so-called Cv mode, that is, ascertaining the approach speed of an object, can be performed. The background correction described above and the rationalization can then be dispensed with, so that the raw signals are recorded continuously inside a range gate, and in the control unit now only the zero crossovers of the raw signal are evaluated. Since in this evaluation mode the corresponding algorithm is examined for each sampled value, the data are then present in real time; that is, the requirement for 10 ms, for instance, of switchover time from the distance measurement to the Cv mode can be met for the precrash mode as well. In block 4, routines for furnishing calibration coefficients and parameters for the aforementioned gain compensation in block 3 can also be furnished.

In block 5, a data compression is indicated, and in block 6, an interface controller is shown, which makes its output signals available to an external control unit 7. The interface controller in block 6 can be constructed such that the data for connection to a standardized bus system, for instance the so-called CAN bus in a motor vehicle, are prepared.

The activation of the data compression can be varied, for instance by the external control unit 7 via the interface controller 6, by a diagnostic or servicing computation module 8, or by the block 4 for controlling the evaluation mode. For example, the calibration coefficients and the measured values in the Cv mode, because of the slight data quantities, need not necessarily be sent in compressed form.

In block 9, a delay triggering means is also shown, with which in a manner known per se a trigger for the starting and ending values in the transmission of the raw signals of the radar sensor is controlled.

1. A method for evaluating the data from a system for detecting objects, in particular for a motor vehicle, in which
with a radar sensor, the radar signals reflected from the object are processed to ascertain the distance (d) and/or the relative or approach speed (Cv) of the object, characterized in that
the digital signals of at least one channel (I, Q) of the radar sensor are processed until a first evaluation capability is obtained as a distance signal (d) or as an approach speed signal (Cv); and that
a mode switchover (4) for the evaluation as a distance signal (d) as an approach speed signal (Cv) is effected, with which it is defined which data will be ascertained and made available to an interface (6) between the radar sensor and a downstream control unit (7):

2. The method as recited in claim 1, characterized in that
the digital signals from at least one channel (I, Q) of the radar sensor, after each sampling operation, are delivered to a data buffer with a predetermined slot width and then, within the slot width, are processed (1, 2) by means of a median filtration operation; and that
the thus-processed signals are further processed jointly in the following evaluation modes (3, 5, 6).

3. The method as recited in claim 1, characterized in that
within a first evaluation mode for distance measurement (d), the digital signals are subjected to a background correction and after that a rationalization of the signal to be evaluated is performed (3).

4. The method as recited in claim 3, characterized in that
the digital signals are processed (3) with a matching filter.

5. The method as recited in claim 3, characterized in that
within a second evaluation mode for measuring the approach speed (Cv) of the object, the background correction and the rationalization are skipped.

6. The method as recited in claim 1, characterized in that
when there is more than one channel (I, Q) in the radar sensor, a gain compensation (3, 4) is performed at different levels of the channels (I, Q).

7. The method as recited in claim 1, characterized in that
the signals processed in the evaluation modes are subjected to a data compression (5).

8. A circuit arrangement for performing the method as recited in claim 1, characterized in that
in the radar sensor, there are storage means and computation modules for performing and switching over the evaluation modes; and that
in the radar sensor, there is an interface controller (6), by which the radar sensor can be connected to a downstream control unit (7).

9. The circuit arrangement as recited in claim 8, characterized in that
the interface controller (6) is constructed such that the data are prepared for connection to a standardized bus system (CAN bus).

10. A data processing program for performing the method as recited in claim 1 and/or for controlling the storage means and/or the digital computation modules.
